(19) United States
(12) Patent Application Publication
(10) Pub. No.: US 2016/0091351 A1
(43) Pub. Date: Mar. 31, 2016

(54) AIR FLOW MEASURING DEVICE

(71) Applicant: YOW JUNG ENTERPRISE CO., LTD., KAOHSIUNG CITY (TW)

(72) Inventor: SHUN-CHI HUANG, KAOHSIUNG CITY (TW)

(21) Appl. No.: 14/499,439

(22) Filed: Sep. 29, 2014

(51) Int. Cl. G01F 1/00

(52) U.S. Cl. CPC G01F 1/00

(57) ABSTRACT

An air flow measuring device includes a body having an air path defined in the lower thereof. An entrance and an exit are respectively defined in the body and communicate with the first end and the second end of the air path. The air path has a curved section and an inclined guiding portion is located at the curved section so as to cover the recessed area of the curved section such that the moisture or liquid in the air cannot be trapped in the recessed area in the curved section of the air path.

### BACKGROUND OF THE INVENTION

1. Fields of the Invention

The present invention relates to a measuring device, and more particularly, to an air flow measuring device which prevents accumulated liquid from being trapped in the device and is easily used.

2. Descriptions of Related Art

U.S. Pat. No. 7,062,964 discloses a heating resistor type flow measuring device which introduces air into the device from the sub-path. However, the sub-path has a curved section which may trap moisture in the air in the curved section, and the moisture eventually is trapped in the sub-path in liquid form.

U.S. Pat. No. 7,752,908 discloses an equipment for measuring gas flow rate having an adjacent external surface protrusion, wherein the curved section of the sub-path has a drain hole for draining the accumulated liquid. Nevertheless, the drain hole has to be drilled at the curved section of the sub-path and that causes the manufacturing process to be complicated and the manufacturing cost is increased.

The present invention intends to provide an air flow measuring device that eliminates the shortcomings mentioned above.

### SUMMARY OF THE INVENTION

The present invention relates to an air flow measuring device and comprises a body having an air path defined in the lower thereof. An entrance is defined in the body and communicates with the first end of the air path. The air path has a curved section and a guiding portion located at the curved section. The guiding portion is an inclined portion and covers the recessed or corner area of the curved section. An exit is defined in the body and communicates with the second end of the air path.

The primary object of the present invention is to provide an air flow measuring device wherein the curved section of the air path has an inclined guiding portion which covers the recessed or corner area of the curved section so that no accumulated liquid will be trapped in the recessed or corner area of the curved section.

Another object of the present invention is to provide an air flow measuring device wherein no drain holes are needed to be drilled in the air path.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the air flow measuring device of the of the present invention;

FIG. 2 shows that the corner or recessed area of the curved section of the air path is covered so that liquid is not trapped in the curved section, and

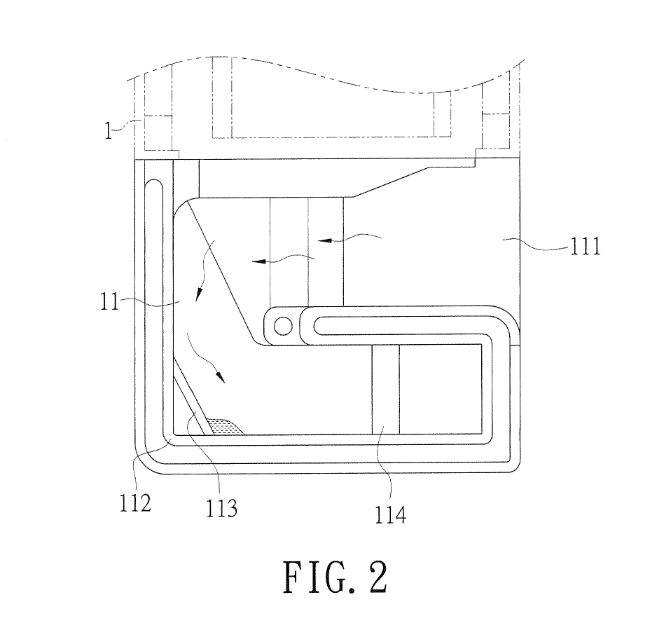

FIG. 3 shows that the liquid flows out from the exit of the air path of the air flow measuring device of the present invention.

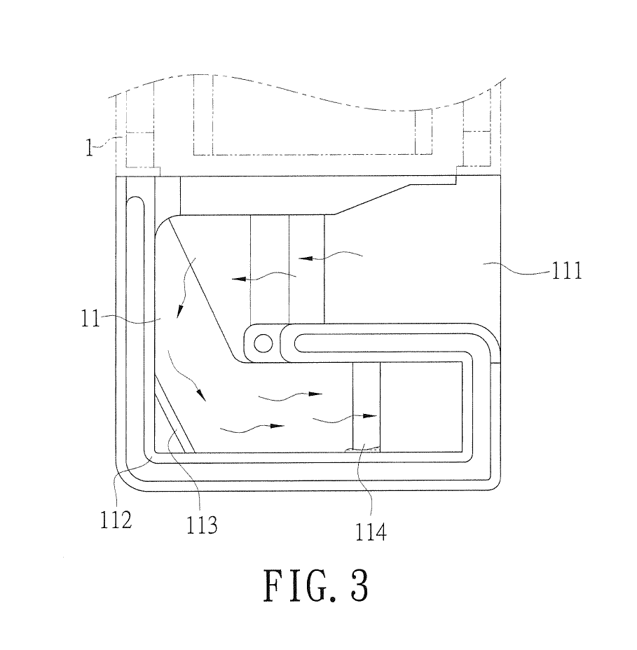

### DETAILED DESCRIPTION OF THE PREFERRED EMBODIMENT

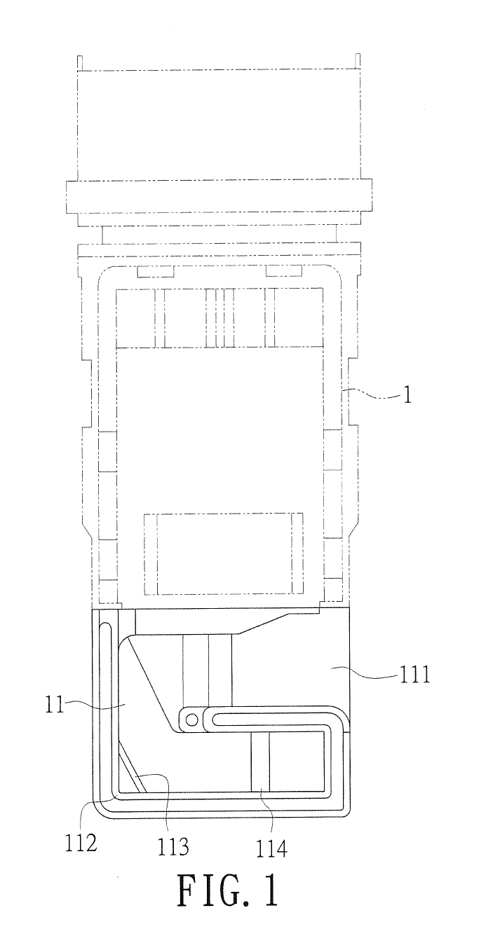

Referring to FIG. 1, the air flow measuring device of the present invention comprises a body 1 having an air path 11 defined in the lower thereof. An entrance 111 is defined in the body 1 and communicates with the first end of the air path 11. The air path 11 has a curved section 112 and a guiding portion 113 is located at the curved section 112. In detail, the guiding portion 113 is an inclined portion and covers a recessed or corner area of the curved section 112 such that no trapping area is formed in the air path 11. The air flow is able to smoothly flow through the air path 11. An exit 114 is defined in the body 1 and communicates with the second end of the air path 11.

The external air is introduced into the air path 11 via the entrance 111 and the air flows along the air path 11. When the air passes the curved section 112, due to that the recessed or corner area of the curved section 112 is covered by the inclined guiding portion 113, the air flows smoothly along the guiding portion 113 and toward the exit 114. The moisture or liquid in the air cannot be trapped in the recessed or corner area of the curved section 112 so that the moisture or liquid will flow out from the exit 114.

It is noted that air flow measuring device of the present invention does not need any drain hole so that the manufacturing process and cost are reduced. The air can smoothly flows through the entire air path 11, and the moisture or liquid in the air cannot be trapped in the recessed or corner area of the curved section 112.

While we have shown and described the embodiment in accordance with the present invention, it should be clear to those skilled in the art that further embodiments may be made without departing from the scope of the present invention.

What is claimed is:

1. An air flow measuring device comprising:
a body having an air path defined in a lower thereof, an entrance defined in the body and communicating with a first end of the air path, the air path having a curved section and a guiding portion located at the curved section, the guiding portion being an inclined portion and covering a recessed area of the curved section, an exit defined in the body and communicating with a second end of the air path.
